(19) United States
(12) Patent Application Publication
(10) Pub. No.: US 2024/0296403 A1
(43) Pub. Date: Sep. 5, 2024

(54) Systems and Methods for Production Order Generation and Workflow Automation

(71) Applicant: Gustavo Trejos, Odessa, FL (US)

(72) Inventor: Gustavo Trejos, Odessa, FL (US)

(21) Appl. No.: 18/177,239

(22) Filed: Mar. 2, 2023

(51) Int. Cl. G06Q 10/0633; G06Q 10/0875

(52) U.S. Cl. CPC G06Q 10/0633; G06Q 10/0875

(57) ABSTRACT

Systems and methods for a work order generation system for a construction project using data analytics and machine learning to aggregate data from multiple construction jobs of the same user and creating a database to automate the production, scheduling, and installation process. The work order system has a template, an information policy, and a work order manager. The information policy is configured to identify message data for a construction project including construction model data associated with a construction model and builder data. The message data is placed into the template using an information policy. A work order for performing a group of tasks for the construction project from the template uses a work order policy, enabling performing tasks for the construction project having a designated stock keeping unit for each construction model retained in a location specific database.

### BACKGROUND OF THE INVENTION

### 1. Field of the Invention

This invention relates, generally, to construction models, and in particular, to managing tasks performed for new construction jobs using a production order generation system, a system comprising instructions which, when the program is executed by a computer, cause the computer to carry out the steps of aggregating data, storing data, and automating the workflow process.

### 2. Background Art

A production order is an order issued within a company to produce a certain quantity of material within a designated period of time. Work orders provide information directly pertaining to a maintenance task and/or project and they outline a process for completing that task for a customer by an assigned individual. In particular, work orders include details of including, but not limited to, who authorized the job, the scope of work, who it was assigned to, and what is expected. For example, a work order is a task that may be scheduled and assigned to a specific individual. Depending on the field of use, business type, and/or facility, a work order may be a manual request sent by a requester including, but not limited to, a builder, a purchasing department, a staff member, a customer, a resident, and/or a technician. The manual work order may be configured to alert an individual including, but not limited to, a sales representative and/or a maintenance staff of a task that needs to be completed. Although work orders are primarily utilized in the construction industry for service requests, it is within the scope of this invention for work orders be used for any tasks within any industry including, but not be limited to, a quote for a good and/or a service, an estimate of labor, material, and/or equipment, a product request, an inspection request, and/or an audit request. The lifecycle of a work order includes creation, completion, and recording. In particular, a work order workflow may include, but is not limited to, task identification, requesting a work order, scheduling a work order, collecting customer information, assigning and completing the work order, documenting and closing the work order, and storing and analyzing the work order.

Currently, work orders may be manually created by a user initially collecting data from a production order and recording the data on a piece of paper and then manually inputting the collected data into a spreadsheet. In an example, a user manually facilitates the monitoring and the production, scheduling, and installation process based on the data associated with the work order. This current system for work order processing is inefficient in that it is time consuming and prone to human errors. Especially in circumstances when a large amount of work orders have been created, due to a lack of ability for a user to accurately manually monitor and process each transaction due to the volume of work orders, there is no way to efficiently track all of the materials, jobs, and/or payments. As a result, a loss in costs may be incurred. Further, it requires many users within a team to accomplish manual monitoring and work order processing within an organization. This example is not described in a limiting sense, as work order and production order generation may differ from company-to-company and is not limited to a spreadsheet.

In another example, a company may use software configured for supply chain collaboration, for example, to manage the real time communications between trade partners and superintendents or construction managers. Some existing software programs allow trade partners to view, accept, and ship materials or perform labor based on purchase orders from home builders. However, this software does not solve the internal issue of organizing the production. Thus, there is a need for a software program to solve the production model parts organization as well as to manage the production step-by-step and process the job messages. Therefore, it would be more desirable to have a method and system for work order management that eliminates the need for manual monitoring and processing of data, eliminates the need for an excessive number of users performing the monitoring and processing of data, and eliminates the associated costly human errors, overlooked orders and builder back charges. Thus, there is a need for automating work order management, for example, the production, schedule, and installation processes of a work order across an organization.

However, in view of the prior art considered as a whole at the time the present invention was made; it was not obvious to those of ordinary skill in the pertinent art how the identified needs could be fulfilled.

### SUMMARY OF THE INVENTION

The long-standing but heretofore unfulfilled need for systems and methods for a work order generation system for a construction project using data analytics and machine learning to aggregate data from multiple construction jobs of the same user and creating a database to automate the production, scheduling, and installation process. The work order system has a template, an information policy, and a work order manager. The information policy is configured to identify message data for a construction project including construction model data associated with a construction model and builder data. The message data is placed into the template using an information policy. A work order for performing a group of tasks for the construction project from the template uses a work order policy, enabling performing tasks for the construction project having a designated stock keeping unit for each construction model retained in a location specific database and which also includes improvements that overcome the limitations of prior work order generation systems, is now met by a new, useful, and non-obvious invention.

The work order manager is referred to as the Nabla work order. Data analytics and machine learning are used to aggregate data from multiple construction jobs of the same user and create a database to automate the production, schedule, and installation process. It is within the scope of this invention for a user to include, but not be limited to, a builder. It is an important aspect of the Nabla work order to create a database to automate the production, scheduling, and installation process. In a preferred embodiment, the automated process imports new Job Message Data from Email or API requests. For example, a user such as, a builder, any entity that brings in receiving jobs, any entity going through a job site, and/or a customer, will email the manufacturer a construction model and the blueprint of the construction model in an attempt to request a price quote for a New construction job. A construction and/or home design model is associated with at least one installation item and/or product that has to be manufactured and installed.

Next, the automated work order system process comprises a template, an information policy, and a work order manager. A template is configured for collecting message data sent by a user. The message data is builder information and construction model information associated with a construction model. Based on message data, the message type is defined as tasks including, but not limited to, New, Reschedule, Extra PO, Cancelation, Non-Completed, Delivery Confirmation, Maintain records of previous customers, and/or Payment Notice.

The automated work order system comprises the step of validating the message data to extract Job Information. It is within the scope of this invention for job information to include, but not be limited to, Job Number, PO Number, Builder, Project Name, Model, Elevation, Address, and/or Builder Contact Information. It is within the scope of this invention for the Project Name to be the name of a community in which a record of models are associated.

The automated work order system comprises the step of using proprietary data to build into the work order generating system for each construction model. The work order generating system will match the Job Model with a Construction Model in the database and use history production data to create a list of pieces to produce and/or at least one installation item and/or product that has to be manufactured and installed for the Construction Model. The algorithm will use Builder Name, Model Name, Elevation, and/or when available the Model stock keeping unit (SKU) to find a match in the database or create a new Model.

In a preferred embodiment, a work order system is configured for automating work order management for an organization. It is within the scope of this invention for the tasks of a workflow process to have related subprocesses that are specific to a particular function desired to be automated. It is within the scope of this invention for tasks of work order management to include, but not be limited to, the production, schedule, and installation processes of a work order. The method having a set of instructions and events activation means in which a document, data, and/or a task may efficiently be transferred from a first user to a second user for review and processing with minimal user involvement. For example, the novel workflow management process may be configured to process a work order for approval, aggregate data from a pricing model, validate the data associated with a work order, allocate inventory to a work order, send a message to at least one user regarding the progress of a work order, determine a workflow processes based on the needs of an organization, and automatically attach a workflow process to an event within the workflow.

### BRIEF DESCRIPTION OF THE DRAWINGS

For a fuller understanding of the nature and objects of the invention, reference should be made to the following detailed description, taken in connection with the accompanying drawings, in which:

FIG. 1 is an illustration of a block diagram of the novel work order environment in accordance with an illustrative embodiment;

FIG. 2 is an illustration of a flow chart of a process for managing a job quote workflow in accordance with an illustrative embodiment;

FIG. 3 is an illustration of a flow chart of a process for managing a job production workflow in accordance with an illustrative embodiment;

FIG. 4 is an illustration of a flow chart of a process for managing a job installation workflow in accordance with an illustrative embodiment;

FIG. 5 is an illustration of a flow chart illustrating actions performed by the work order environment of FIG. 1 when performing the computer-implemented data processing method in accordance with an illustrative embodiment;

FIG. 6 is an illustration of a flow chart illustrating actions performed by the work order environment of FIG. 1 and continuing from FIG. 5 when performing the computer-implemented data processing method in accordance with an illustrative embodiment;

FIG. 7 is an illustration of a flow chart illustrating an embodiment of actions performed by the work order environment of FIG. 1 when performing the computer-implemented data processing method an illustrative embodiment;

FIG. 8 is a continued illustration of the embodiment of FIG. 7 in accordance with an illustrative embodiment;

FIG. 9 is an illustration of a flow chart illustrating another embodiment of actions performed by the work order environment of FIG. 1 when performing the computer-implemented data processing method in an illustrative embodiment;

FIG. 10 is a continued illustration of the embodiment of FIG. 9 in accordance with an illustrative embodiment;

FIG. 11 is an illustration of a device showing an operational sequence that may be performed when running the computer program;

FIG. 12 is an illustration of a device showing an operational sequence that may be performed when running the computer program;

FIG. 13 is an illustration of a device showing an operational sequence that may be performed when running the computer program;

FIG. 14 is an illustration of a device showing an operational sequence that may be performed when running the computer program;

FIG. 15 is an illustration of a device showing an operational sequence that may be performed when running the computer program;

FIG. 16 is an illustration of a device showing an operational sequence that may be performed when running the computer program;

FIG. 17 is an illustration of a device showing an operational sequence that may be performed when running the computer program;

FIG. 18 is an illustration of a device showing an operational sequence that may be performed when running the computer program; and

FIG. 19 is an illustration of a device showing an operational sequence that may be performed when running the computer program.

### DETAILED DESCRIPTION OF THE PREFERRED EMBODIMENT

In the following detailed description of the preferred embodiments, reference is made to the accompanying drawings, which form a part hereof, and within which are shown by way of illustrating specific embodiments by which the invention may be practiced. It is to be understood that other embodiments may be utilized and structural changes may be made without departing from the scope of the invention.

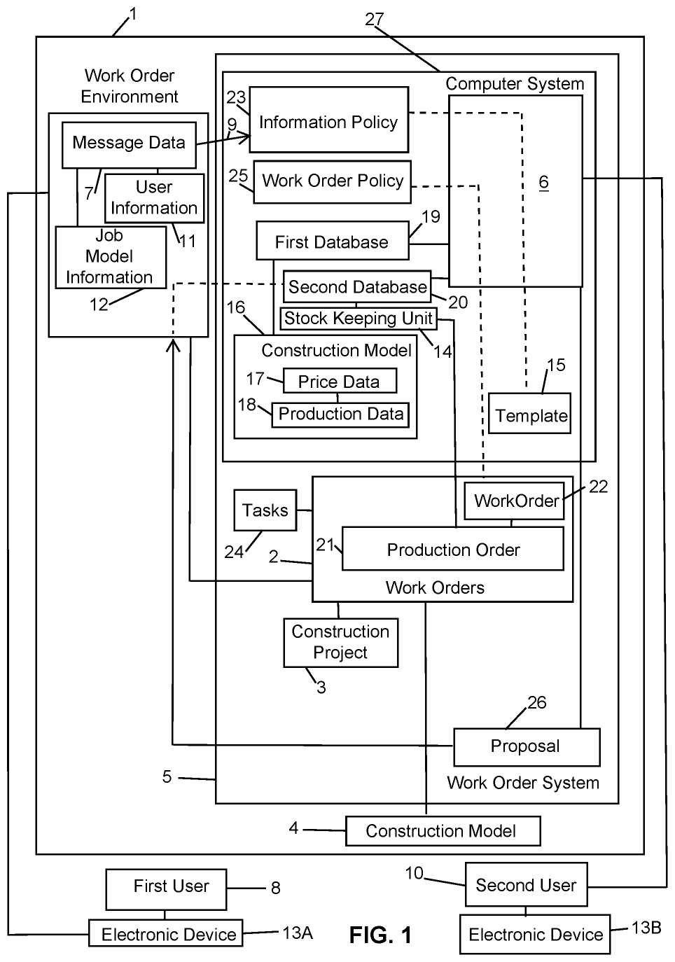

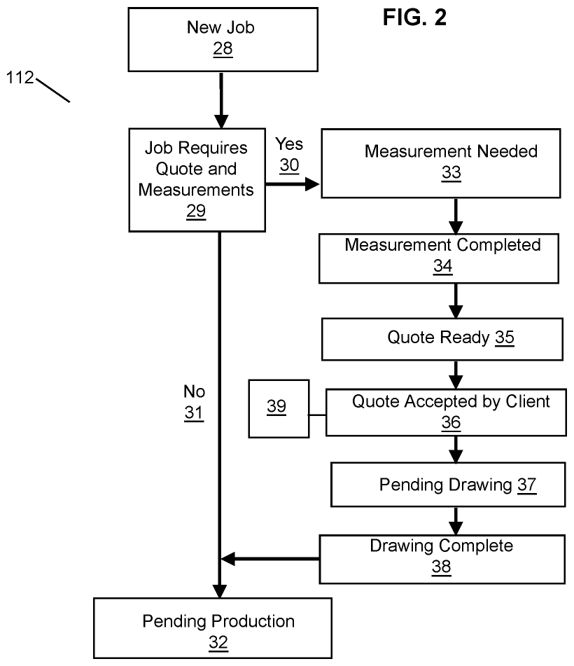

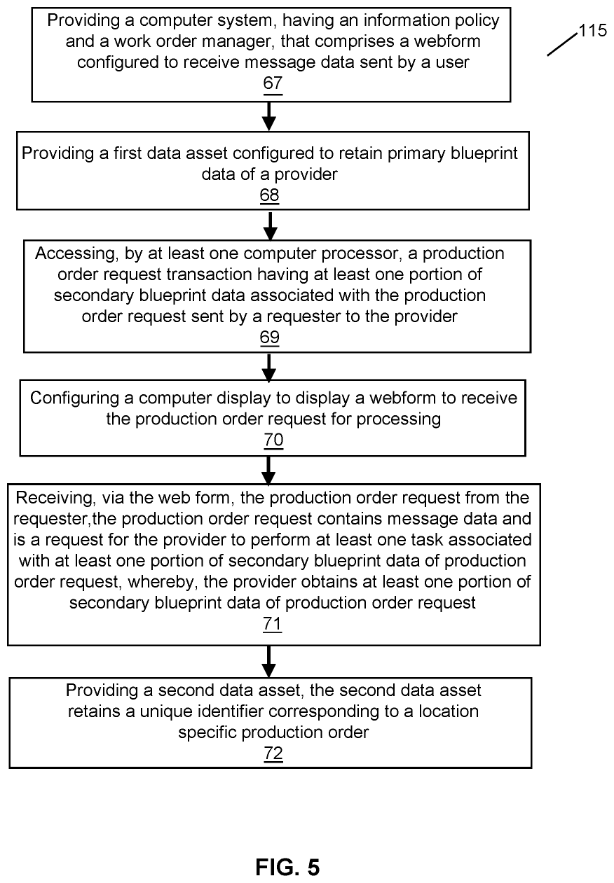

The embodiments illustrated in FIGS. 2-4 are all subsequent workflow process steps that may be performed using the system of FIG. 1 and steps FIGS. 5-10 are all methods based from the underlying principles set forth in the illustration of FIG. 1. In an embodiment, FIG. 1 illustrates a block diagram of a novel work order environment 1. Work order environment 1 is an environment in which at least one work order 2 may be created to perform any project 3 associated with a particular organization. For example, at least one work order 2 may be created to perform construction project 3 based on construction model 4. It is within the scope of this invention for construction project 3 to take several different forms. For example, construction project 3 may be selected from a group comprising a New Job, Reschedule, Extra Production Order (PO), Cancellation, Non-Completed, Delivery Confirmation, and/or Payment Notice.

In this illustrated example of FIG. 1, at least one work order 2 is generated within work order system 5. In an example, work order manager 6 in work order system 5 may generate work orders 2 from message data 7. It is within the scope of this invention for first user 8 to include, but not be limited to, a builder, any entity that brings in receiving jobs, any entity going through a job site, and/or a customer. For example, first user 8 may send 9 by email and/or API request from electronic device 13A, message data 7 to electronic device 13B of second user 10 having work order system 5. In an example, second user 10 may be a manufacturer and/or any entity operating the work order system. In an example, message data 7 received by second user 10 is a construction model and the blueprint of the construction model that first user 8 sends 9 to work order manager 6 of second user 10 in an attempt to request a price quote for a new construction job. In the illustrative examples, information, such as message data is located in a database. For example, construction model 16 information such as price data 17 and production data 18, model elevation, blueprint data, a stock keeping unit number, and/or construction model information may be located in a computer aided design system, as a part management system, or any other system such as at least one database. These systems may be located in differing locations such as a location specific database, a building manufacturer, a database of the work order system, a third party, a third-party parts supplier, a customer, and/or any other source capable of storing such information.

FIG. 1 shows message data 7 including user information 11, job model information 12, instructions, part notes, a bill of materials, a stock keeping unit, or any other identifying information as it pertains to a construction design model. It is within the scope of this invention for user information 11 to include, but not be limited to, Job Number, PO Number, Project Name, Model, Elevation, Address, Builder Contact Information and/or a stock keeping unit number. It is within the scope of this invention for job model information 12 to include, but not be limited to, a blueprint of a construction design model and/or a stock keeping unit number. As used herein, the phrase “at least one”, when used with a list of items, means different combinations of one or more of the listed items may be used. Further, only one of each item in the list may be required. In particular, “at least one” means any combination of items and number of items may be used from the list, but not all of the items in the list are required. The item may be a particular object, a thing, or a category having one location and/or a plurality of locations.

In an embodiment, a builder may be building one thousand homes in a first location having a first division being in Tampa, FL and one thousand homes in a second location having a second division being Orlando, FL. First user 1 may have electronic device 13 such as a smart phone, a computer, and/or a tablet. Each differing division will have homes with different model numbers, different elevations and/or features subset within a model, and different prices. Each home is associated with a construction model number. Each construction model number is associated with a list of parts needed to build the corresponding model. A stock keeping unit number is generated for each construction model. First user 1 uses electronic device 13 and emails stock keeping unit number to second user 2 when requesting a production order. Work order system 5 intercepts the email and extracts the data needed to create a work order. A Nabla work order is generated. Errors are automatically identified by the work order system and alerts are generated for requests for corrections.

Referring again to FIG. 1, template 15 and/or web form is employed to reduce the time and effort used to create at least one work order 2. Message data 7 from an email of first user 8 is extracted and transferred to template 15 of novel work order manager 6. Further, template 15 is configured to detect clerical errors and other errors associated with construction model 16 such as discrepancies in pricing data 17 and/or production data 18 when comparing message data 7 from template 15 with construction model data 16 within first database 19. First database 19 retains construction model data 16 being price data 17 and/or production data 18. It is within the scope of this invention for production data 18 to be a list. The list has at least one product. At least one product is assigned to construction model 16. At least one product is configured to be manufactured for and installed as part of construction model 16 as requested by first user 8. It is within the scope of this invention for price data 17 to include, but not be limited to, the cost of each of at least one product from the list. Further, template 15 and/or web form may also increase the accuracy of at least one work order 2 by reducing and/or eliminating the amount of time spent reviewing work order data for message data errors.

A production order is created from stock keeping unit number 14 and/or and blueprint data and/or builder name, model name and elevation, and/or at least one of message data 7 sent from electronic device 13A of first user 8 to second user 10.

FIG. 1. depicts work order manager 6 configured to identify message data 7 sent by electronic device 13A of first user 8. Message data 7 includes user information 11 and job model information 12. In particular, blueprint and model number are required when first user 8 is requesting a quote. When proposal 26 is generated, the price for a construction model is input into a central system where stock keeping unit number 14 is generated for each construction model. Stock keeping unit number 14 and blueprint are sent from a location specific second database 20 to second user 10 as production order 21. Production order 21 intercepted by work order manager 6 and the information is extracted to create a Nabla work order 22. As shown in FIG. 1, work order manager 6 is configured to transfer message data 7 into template 15 using information policy 23 and to create work order 22 for performing at least one task 24 for construction project 3 from template 15 using work order policy 25. In particular, work order manager 6 performs these operations to enable performing at least one task 24 for construction project 3 on construction model 4. As described herein, it is within the scope of the current invention for “a policy” to include, but not be limited to, at least command. Further, the policy may have data and/or a value configured for applying at least one command. A policy may have a command with at least one instruction associated therewith.

Referring again to FIG. 1, message data 7 is associated with at least one task 24 for work order 22. In particular, each portion of message data 7 has a corresponding task 24. It is a preferred embodiment of the current invention for at least one task 24 to include, but not be limited to, the automation of a quote, production, scheduling, and/or installation. Work order manager 6 identifies message data 7 with at least one task 24. This identification may be executed using information policy 23. The connection of message data 7 with at least one task 24 may be incorporated in template 15. In particular, message data 7 deposited into template 15 corresponds directly with at least one task 24 within template 15 in an attempt to maximize the efficiency in the process of generating work order 22. For example, template 15 may identify at least one task 24 with message data 7 using information policy 23. Information policy 23 may identify at least one installation item and/or product list that needs to be manufactured and installed for a particular construction model 4 by working inward of construction model 4, such that information policy 23 links message data 7 using builder name, construction model and elevation subset of construction model to match job model information 12 with a construction model 16 in first database 19. It is envisioned that other commands may be implemented for use with information policy 23 in other embodiments.

It is within the scope of this current invention for information policy 23 to define an order for instructions to perform task 24 from a plurality of tasks. For example, if the Message Type=“New Job”, create a New Job, mark it as pending confirmation, assign a default Measures Technician, a default Sales Manager, and assign Model information. In another example, using price data aggregated from the Model price history, notify the Billing Department of any price discrepancy. In yet another example, using model production data, the system determines the number of pieces of the same type that need to be produced based on the model order history for a period of time. In another example, if Message Type=“Reschedule”, set a new Installation Date, and notify the Schedule Department and Sales Manager. In another example, if Message Type=Cancelation, set the job as “Canceled” and assign a Cancelation Date, notify the Schedule Department and Sales Manager. In another example, if Message Type=“Non-Completed”, set the job as “Fail Supervision” and notify the Schedule Department, Sales Manager, and Installer. In another example, if Message Type=“Delivery Confirmation”, set the job as “Completed” and notify the Billing Department to invoice the Builder. In a final example, if Message Type=“Payment Notice”, set the job as “Paid” and notify the Billing Department.

It is envisioned that work order 22 is custom created for a particular organization and/or a type of construction model project and/or for any customer. When message data 7 is transferred to template 15, work order manager 6 matches a blueprint from job model information 12 with a construction model 16 of first database 19. Information policy 23 may specify at least one installation item associated with the blueprint 12 that is needed for work order 22. Information policy 23 defines the type of installation item needed for work order 22.

Work order manager 6 may be carried out in software, hardware, and/or firmware. In the embodiment when work order manager 6 is carried out in software, the operations executed by work order manager 6 may be implemented in program code configured to run on hardware, such including, but not limited to, a processor unit. In an embodiment when work order manager 6 is carried out in firmware, the operations executed by work order manager 6 may be implemented in program code and data and stored in persistent memory to run on a processor unit. In the embodiment when work order manager 6 is carried out in hardware, the operations executed by work order manager 6 may be implemented by circuitry such as a circuit system, an integrated circuit, an application specific integrated circuit, and/or a programmable logic device. FIG. 1 illustrates work order manager 6 being carried out within computer system 27. It is within the scope of this invention for computer system 27 to include, but not be limited to, a physical hardware system having a data processing system in communication with electronic device 13A, 13B.

FIG. 2 illustrates a job quote workflow process 112. If new job 28 does not require 31 a quote and measurements 29, the process continues to pending production 32. If new job 28 requires 30 a quote and measurements 29, the process continues with a request for measurements needed 33. It is within the scope of this invention for the job to require 31 a quote when a new model and/or a custom job is requested. When measurements have been completed 34, a quote is prepared 35 and sent to a client. The quote is reviewed by the client. When the quote is accepted 36 by the client, the drawing process is pending 37. When the drawings are complete 38, the process continues with a pending production 32. It is within the scope of this invention for notification 39, such as an email, to be sent. For example, when a quote is accepted 36 by a client, email 39 may be automatically sent to a sales member and/or a drawing professional. In another example, email 39 may be sent to a production manager when a job is ready for a production schedule.

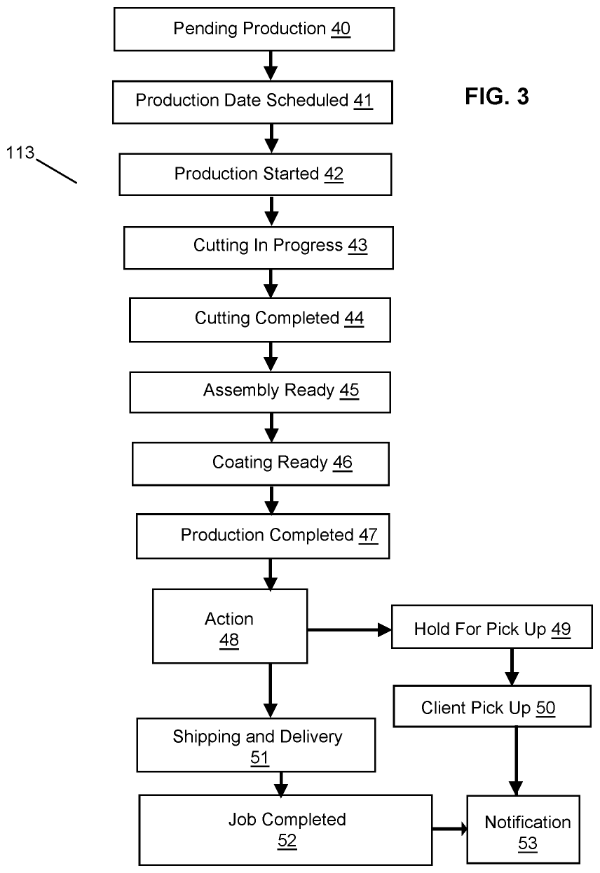

FIG. 3 illustrates an embodiment in the home model construction industry of a job production workflow 113. The step of pending production 40 is followed by scheduling a production date 41. When a manufacturer has started production 42, the cutting of material is in progress 43. When the cutting of material is completed 44, the manufactured components are ready to be assembled 45. Once the components are assembled 45 to form a completed part, it is within the scope of this invention for the step of applying a coating 46 to the part to be performed. When production of the manufactured item and/or part has been completed 47, action 48 occurs. It is within the scope of this invention for action 48 to include, but not be limited to, holding 49 the manufactured product for customer pick-up. In an example, a client may pick up 50 the item. It is also within the scope of this invention for action 48 to include, but not be limited to, shipping and delivering 51 the completed manufactured item to a destination. At the end of this job production workflow, the next status is job completed 52. It is within the scope of this invention for notification 53 to be generated after job completion 52. In a first example, an email is generated and sent to a client when production is completed 52 and/or hold for pick-up 49 and/or when the client picks up 50 the order.

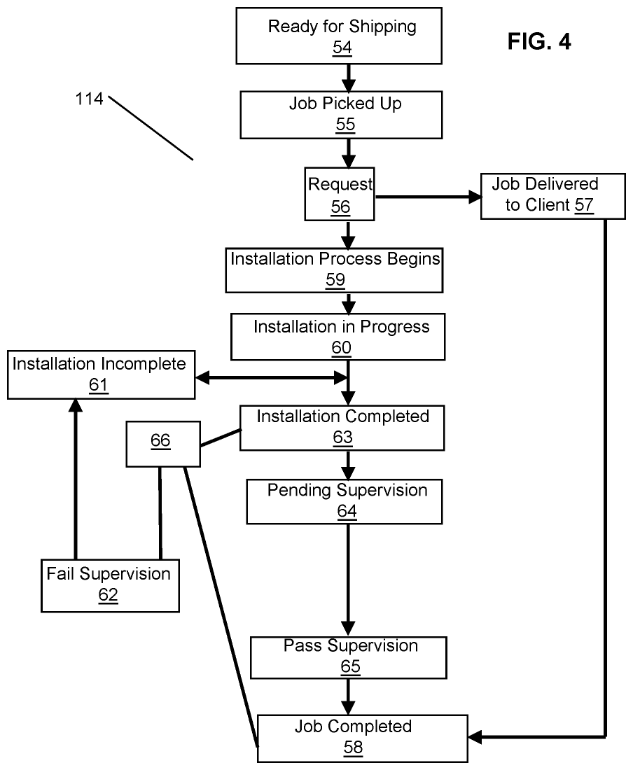

FIG. 4 illustrates an embodiment of a job installation workflow 114 of this novel system. When a manufactured product is completed and ready for shipping 54, the job is picked up 55. The process may continue based on need 56. If a job needs to be delivered to a client, the job is delivered 57 to the client. After the job is delivered 57 to the client, the job is completed 58. In another example, if the job needs 56 an installation, the installation process 59 begins. After installation process 59 begins, the installation process may be in different stages of progress 60. For example, if the installation is incomplete 61, the installation will fail supervision 62. In another example, if the installation is completed 63, it will then be pending supervision and/or inspection 64 until the installation job passes supervision/inspection 65. Once supervision/inspection is passed 65, the job is completed 58. The system may generate notifications 66 such as emails. For example, management may be emailed notification 66 when installation is complete 63. In another example, management may be emailed notification 66 when a job fails supervision/inspection. In another example, a finance department may be emailed notification 66 when a job is completed 58.

FIG. 5 shows a flow chart of the novel steps 115 of performing a computer-implemented data processing method within the work order environment of FIG. 1 for receiving and facilitating the processing of a production order request via a web form in a maintenance work order workflow. In the first step 67, the computer system has a template configured to receive message data sent by a user. The computer system has an information policy and a work order manager. The next step 68 shows a first data asset of a provider, such as second user 10 of FIG. 1 is provided. It is within the scope of this invention for a provider to include, but not be limited to, the manufacturer or any entity capable of providing goods and/or services. It is within the scope of this invention for a data asset to include, but not be limited to, any entity that has data. The first data asset retains primary blueprint data such as price data 17 (FIG. 1) and production data 18 (FIG. 1) of construction model 16 (FIG. 1). It is within the scope of this invention for the first data asset to be first database 19 of FIG. 1. The first data asset or database may be maintained by second user 10 (FIG. 1), a third party, and/or a manufacturer. The next step 69 is accessing, by at least one computer processor, a production order request transaction having at least one portion of secondary blueprint data being message data 7 (FIG. 1) associated with the production order request sent by a requester or first user 8 (FIG. 1) to provider or second user 10 (FIG. 1). It is within the scope of this invention for a requestor to be the first user of FIG. 1. It is within the scope of this invention for the requestor to send message data 7 (FIG. 1) being user information 11 (FIG. 1) and job model information 12. At least one portion of secondary blueprint data is job model information 12 (FIG. 1).

Referring again to FIG. 5, step 70 illustrates the step of configuring a computer display to display a web form. The web form is configured to receive the production order request or message data 7 (FIG. 1) for processing. The following step 71 depicts the step of receiving, via the web form, the production order request from the requester. It is within the scope of this invention for a web form to be template 15 (FIG. 1) and/or an HTML form such as an online page configured for user input of message data 7 (FIG. 1). The production order request contains message data 7 (FIG. 1) and is a request for the provider or second user 10 (FIG. 1) to perform at least one task 24 (FIG. 1) associated with at least one portion of secondary blueprint data, such as message data 7 (FIG. 1) of production order request, whereby, the provider or second user 10 (FIG. 1) obtains at least one portion of secondary blueprint data of production order request.

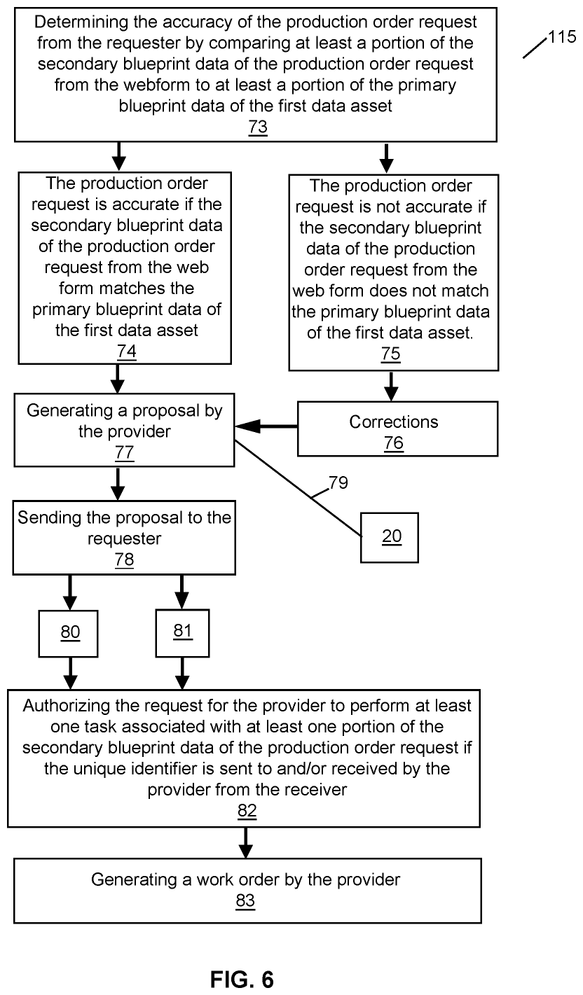

The following step 72 is shown in FIG. 5 to provide a second data asset such as second database 20 (FIG. 1) of provider or second user 10 (FIG. 1), and/or third party 81 (FIG. 6). The second data asset 20 (FIGS. 1 and 6) retains a unique identifier, such as stock keeping unit number 14 (FIG. 1), by either the provider, the receiver, and/or a third party. The unique identifier corresponding to a location specific construction model for a production order.

Referring now to FIG. 6, which is a continuation of the steps 115 of FIG. 5, step 73 describes the step of determining the accuracy of the production order request from the requester by comparing at least a portion of the secondary blueprint data of the production order request from the web form to at least a portion of the primary blueprint data of the first data asset. The secondary blueprint data may be a copy and/or original of a construction model blueprint and/or any other identifying information of the builder 11 (FIG. 1) and/or construction model component information 12 (FIG. 1) such as, for a home, structure, and/or building. This step is critical in that for example, the construction job model numbers match on the production order request with the information the manufacturer has on file for the construction models. In particular, the algorithm will use builder name, model name, elevation, and/or stock keeping unit number to find a match in the database or to create a new model. The production order request is accurate 74 if the secondary blueprint data of the production order request from the web form matches the primary blueprint data of the first data asset. The production order request is not accurate 75 if the secondary blueprint data of the production order request from the web form does not match the primary blueprint data of the first data asset. If message data 7 (FIG. 1) of the production order request is not accurate in that there is a clerical error, an internal error, and/or an external error, corrections 76 must be made to the production order request so that the production order request is accurate. Once the production order request is accurate, the next Step 77 describes that a proposal is generated by the provider. In the next step, the proposal is sent 78 to the requester, which may be a builder. The provider generates and/or receives a unique identifier on their own 79 from their database 20, by the requester's database 80, and/or by a database of a third party 81. It is within the scope of this invention for the unique identifier to be a stock keeping unit number associated with location specific construction model information. The unique identifier corresponds to a location specific production order.

FIG. 6 illustrates the next step 82 of authorizing the request for the provider to perform at least one task associated with at least one portion of the secondary blueprint data of the production order request if the unique identifier is sent to and/or received by the provider from the receiver and/or from a third party. The next step following step 82 is generating a work order by the provider 83.

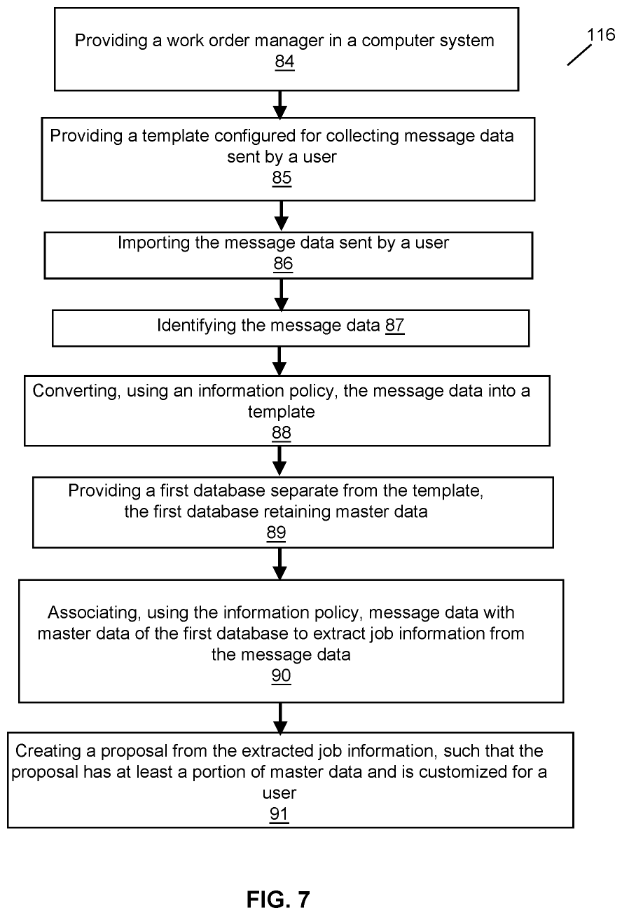

FIG. 7 illustrates an embodiment 116 using the work order environment of FIG. 1. The method depicts step 84 of providing a work order manager in a computer system. At 85, a template, such as a web form, is provided. The template is configured for collecting message data sent by a user. At 86, the message data of the work order environment is imported into the computer system. The message data is sent by the first user or requester. At 87, the message data is identified. At 88, the message data is converted, using an information policy, into a template. At 89, a first database is provided. The first database is separate from the template. The first database retains master data with the bill of material data. At 90, message data is associated, using an information policy, with master data of the first database to extract job information from the message data. At 91, a proposal is created from the extracted job information, such that the proposal has at least a portion of the master data and is customized for a user.

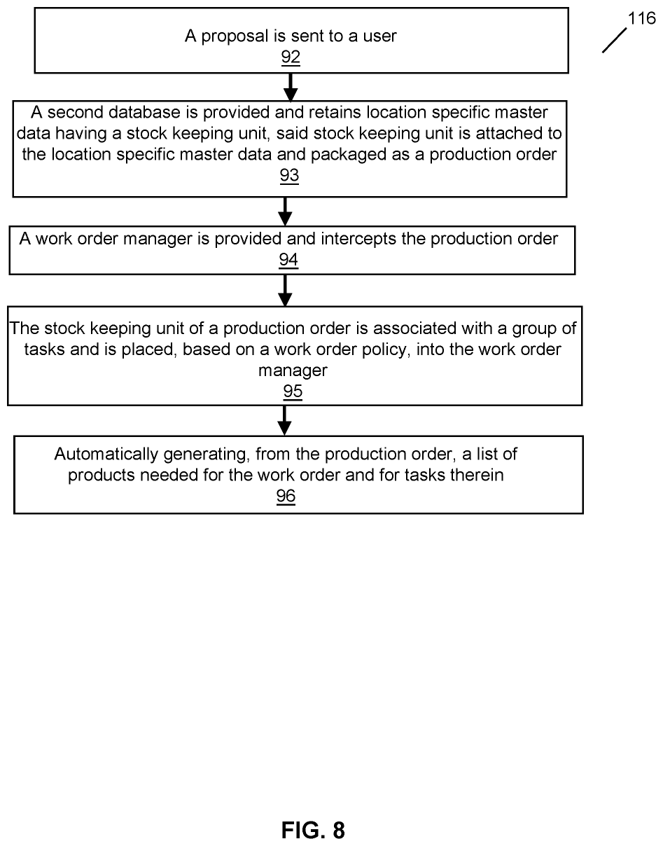

FIG. 8 continues the steps of embodiment 116 from FIG. 7 and at 92, a proposal is sent to a user, based on for example, at least blueprint data of a construction model. At 93, a second database is provided. The second database retaining location specific master data having a stock keeping unit, said stock keeping unit is attached to or associated with the location specific master data and packaged as a production order. At 94, a work order manager is provided. The work order manager is configured to intercept the production order. At 95, the stock keeping unit is associated with a group of tasks. The stock keeping unit of a production order is placed, based on a work order policy, into the work order manager. At 96, the step depicts automatically generating, from the production order, a list of products needed for the work order and for tasks therein.

It is within the scope of this invention for the message data to comprise a construction model and a blueprint. It is also within the scope of this invention for the master data to comprise a list of model data associated with its associated blueprint. It is within the scope of this invention for job information to include, but not be limited to, an associated stock keeping unit, builder name, model, and/or elevation. It is also within the scope of this invention for the proposal to comprise a list of items to produce, based on history production data. It is within the scope of this invention for the location specific master data comprising data for a construction model, an elevation, and/or product pricing. It is within the scope of this invention for a stock keeping unit to comprise a construction model number, elevation, and product pricing.

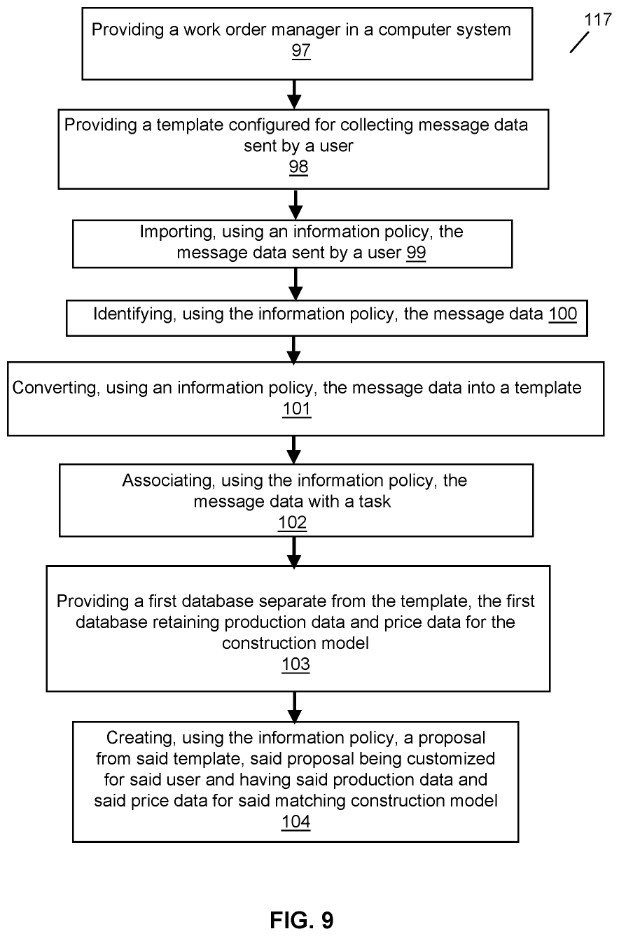

FIG. 9 illustrates an embodiment 117 using the work order environment of FIG. 1 for managing work orders. At 97, the method includes providing a work order manager in a computer system. At 98, the method includes providing a template configured for collecting message data sent by a user. The message data is builder information and construction model information associated with a construction model. At 99, the method includes importing, using the information policy of FIG. 1, the message data sent by a user. At 100, the method includes identifying, using the information policy of FIG. 1, the message data. At 101, the method includes converting, using the information policy of FIG. 1, the message data into a template. At 102, the method includes associating, using the information policy of FIG. 1, the message data with a task. At 103, the method includes providing a first database separate from the template, the first database retaining production data and price data for the construction model. The production data may be a list having at least one product. At least one product is assigned to a construction model. At least one product is configured to be manufactured for and/or installed as part of the construction model as requested by a user. The price data is the cost of each product from the list. At 104, the method includes creating, using the information policy of FIG. 1, a proposal from the template. The proposal being customized for any user and having production data and price data for the matching construction model.

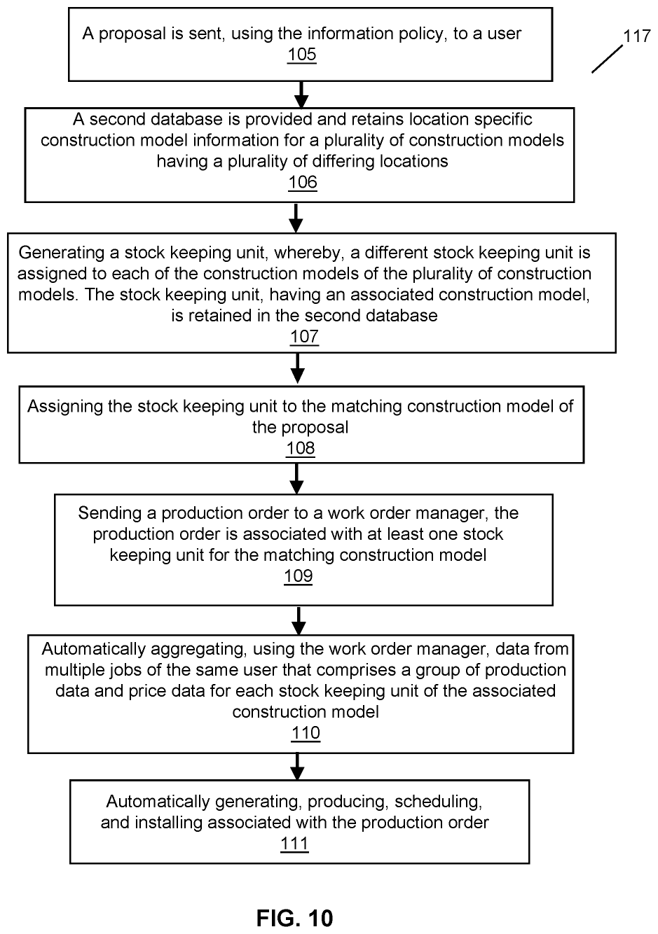

Referring now to FIG. 10, which is a continuation of steps embodiment 117 from FIG. 9 in which at 105 the step of sending, using an information policy, the proposal to a user. At step 106, a second database is provided and retains location specific construction model information for a plurality of construction models having a plurality of differing locations. At 107, the step of generating a stock keeping unit, whereby a different stock keeping unit is assigned to each of the construction models of the plurality of construction models. The stock keeping unit has an associated construction model and is retained in the second database. At step 108, the stock keeping unit is assigned to the matching construction model of the proposal. At step 109, a production order is sent to a work order manager. The production order is associated with at least one stock keeping unit for the matching construction model. At step 110, the work order manager is used to automatically aggregate data from multiple jobs of the same user. This data comprises a group of production data and price data for each stock keeping unit of the associated construction model. At step 111, automatically generating, producing, scheduling, and installing associated with the production order.

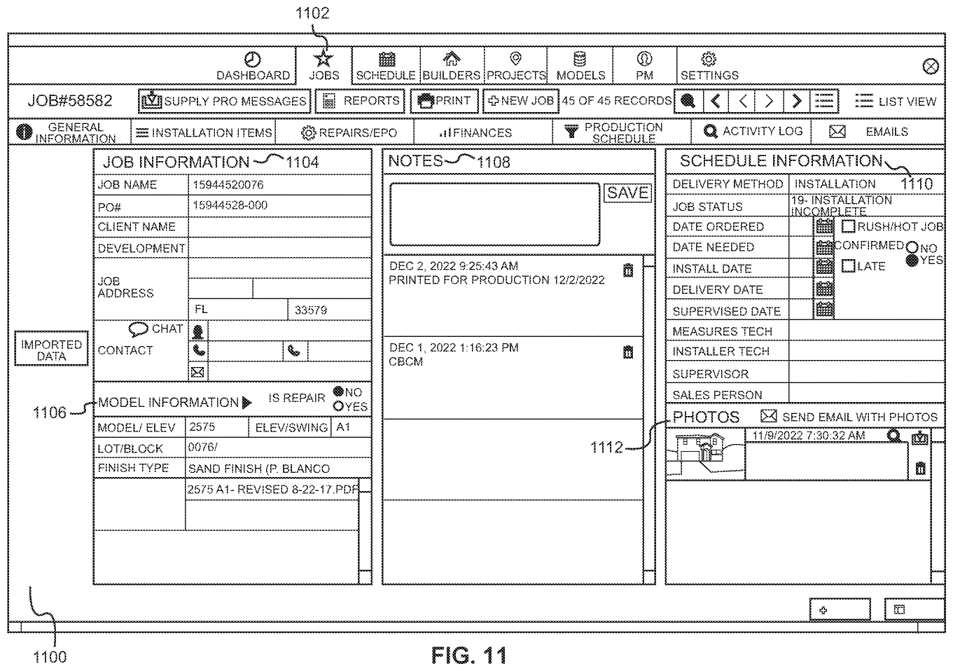

FIG. 11 is an illustration of a display or device including, but not limited to an electronic device, a tablet, a smart phone, and/or a computer having a screen with a graphic user interface. The display shows operational sequence 1100 that may be performed when running the computer program for receiving and facilitating the processing of a production order request via a web form in a maintenance work order workflow. At 1102, the jobs tab may be selected to create a new job. At 1104, job information such as job name, purchase order number, client name, development information, job address, and/or contact information may be manually and/or automatically imported, collected, and/or stored. At 1106, model information such as, model, elevation, lot, block, and finish type may be manually and/or automatically imported, collected, and/or stored. At 1108, notes may be manually and/or automatically imported, collected, and/or stored. At 1110, Schedule information such as, delivery method, job stats, date ordered, date needed, install date, delivery date, supervised date, measures technician, installer technician, supervisor, and/or sales person information may be manually and/or automatically imported, collected, and/or stored. At 1112, photos and/or blueprint data may be manually and/or automatically imported, collected, and/or stored.

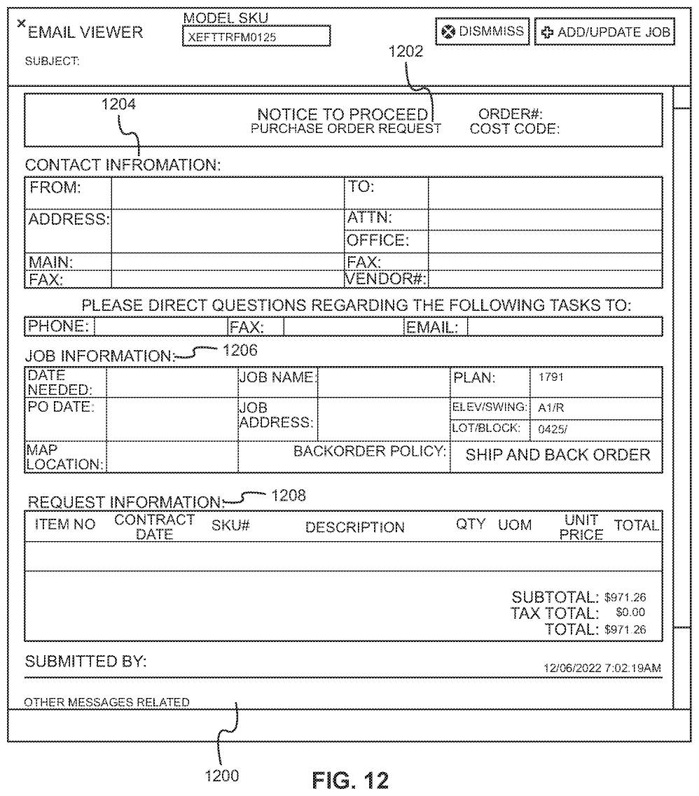

FIG. 12 is an illustration of a display or device including, but not limited to an electronic device, a tablet, a smart phone, and/or a computer having a screen with a graphic user interface. The display shows operational sequence 1200 that may be performed when running the computer program for receiving and facilitating the processing of a production order request via a web form in a maintenance work order workflow. At 1202, webform with a purchase order request having order number and cost code information may be manually and/or automatically imported, collected, and/or stored. It is within the scope of this invention for the job information to be automatically updated in real-time when the computer program compares the data of an email of a customer to the data on file in the computer program system. Previous messages and/or email communications may be stored by the system in a database. For example, the builder and/or customer data is cross compared to the data of the computer program system of the manufacturer so that the correct products are manufactured and the correct pricing is reflected. At 1204, contact information such as, from, address, main, fax, to, attn, office, fax, and/or vendor number may be manually and/or automatically imported, collected, and/or stored. At 1206, job information such as date needed, PO date, map location, job name, job address, plan, elevation, swing, lot, block, and/or backorder policy information may be manually and/or automatically imported, collected, and/or stored. At 1208, request information such as, item no, contract date, SKU No., description, quantity, UOM, unit price, and/or total information may be manually and/or automatically imported, collected, and/or stored.

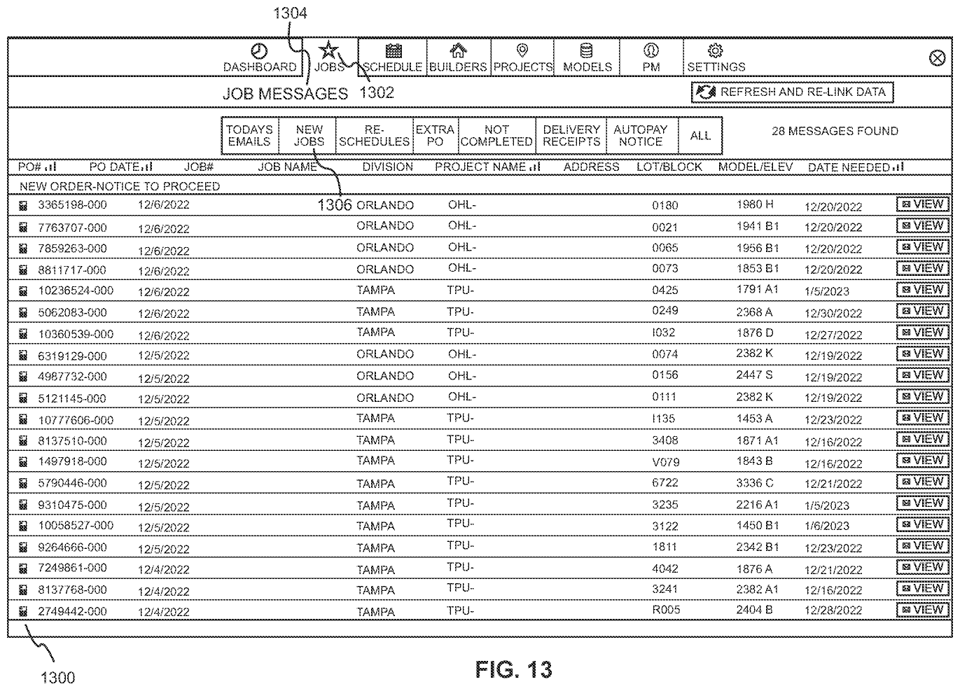

FIG. 13 is an illustration of a display or device including, but not limited to an electronic device, a tablet, a smart phone, and/or a computer having a screen with a graphic user interface. The display shows operational sequence 1300 that may be performed when running the computer program for receiving and facilitating the processing of a production order request via a web form in a maintenance work order workflow. At 1302, the jobs tab may be selected by a user to access messages and a new order-notice. At 1304, job messages are automatically updated in real-time. New job information may be manually and/or automatically imported, collected, and/or stored. At 1306, new job information such as PO No., PO date, job no., job name, division, project name, address, lot, block, model, elevation, and/or date needed may be manually and/or automatically imported, collected, and/or stored.

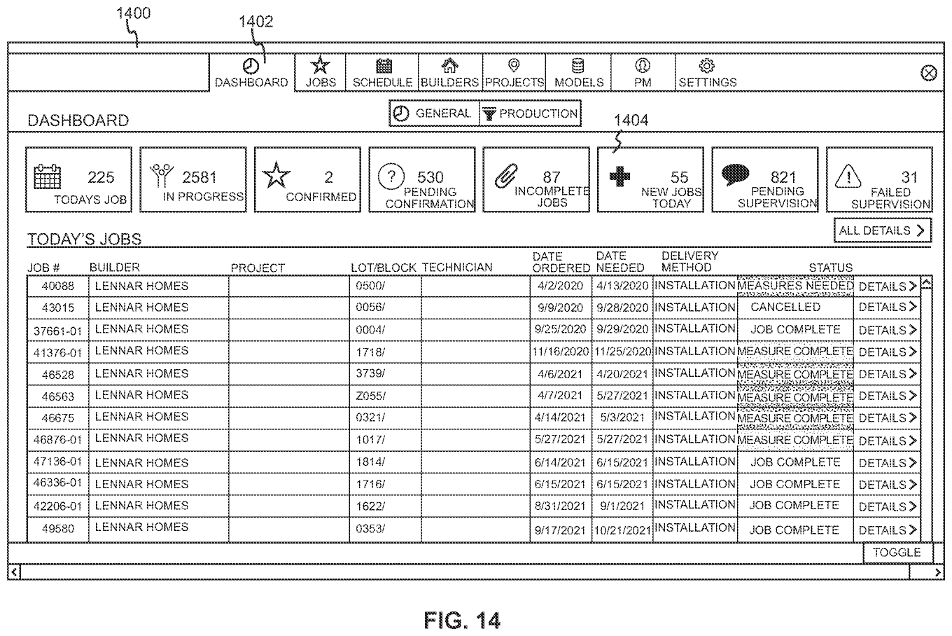

FIG. 14 is an illustration of a display or device including, but not limited to an electronic device, a tablet, a smart phone, and/or a computer having a screen with a graphic user interface. The display shows operational sequence 1400 that may be performed when running the computer program for receiving and facilitating the processing of a production order request via a web form in a maintenance work order workflow. At 1402, the dashboard shows general and production information such as, today's job, in progress, confirmed, pending confirmation, incomplete jobs, now jobs today, pending supervision, and/or failed supervision that may be manually and/or automatically imported, collected, and/or stored. At 1404, the new jobs today tab shows job number, builder, project, lot, block, technician, date ordered, date needed, delivery method, and/or status data that may be manually and/or automatically imported, collected, and/or stored.

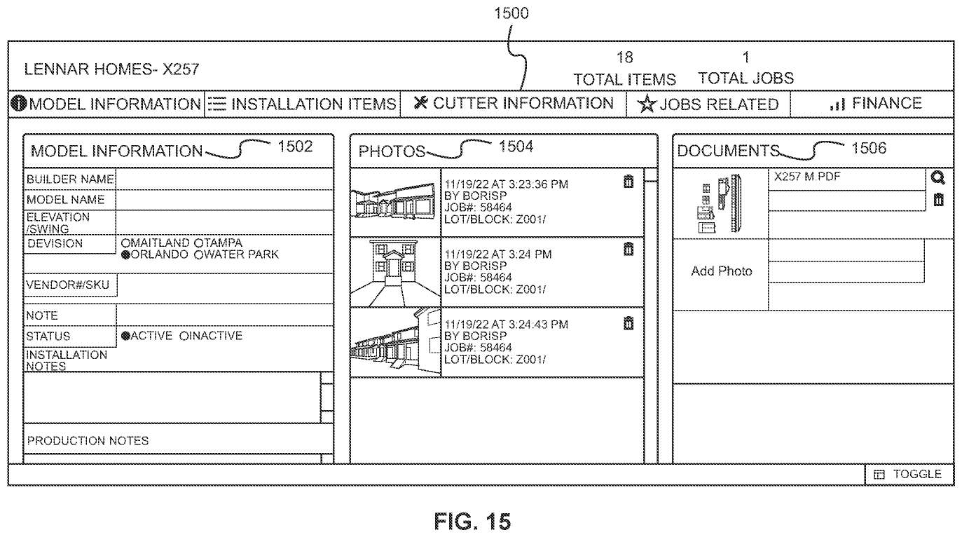

FIG. 15 is an illustration of a display or device including, but not limited to an electronic device, a tablet, a smart phone, and/or a computer having a screen with a graphic user interface. The display shows operational sequence 1500 that may be performed when running the computer program for receiving and facilitating the processing of a production order request via a web form in a maintenance work order workflow. At 1502, model information may be manually and/or automatically imported, collected, and/or stored. At 1504, photos and/or blueprint data of homes may be manually and/or automatically imported, collected, and/or stored. At 1506, a document and/or a photo may be manually and/or automatically imported, collected, and/or stored.

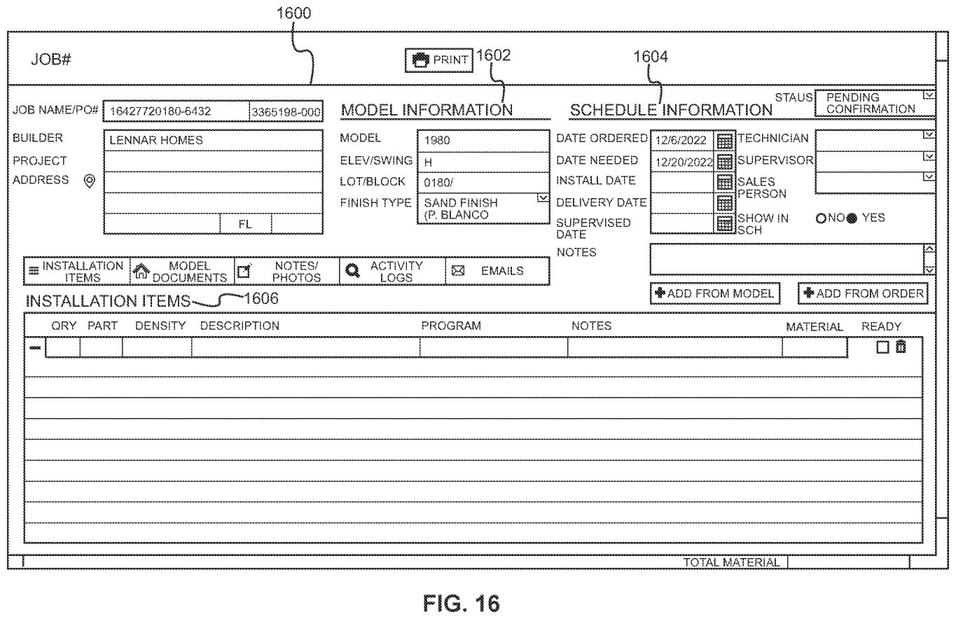

FIG. 16 is an illustration of a display or device including, but not limited to an electronic device, a tablet, a smart phone, and/or a computer having a screen with a graphic user interface. The display shows operational sequence 1600 that may be performed when running the computer program for receiving and facilitating the processing of a production order request via a web form in a maintenance work order workflow. At 1602, model information may be manually and/or automatically imported, collected, and/or stored. At 1604, schedule information may be manually and/or automatically imported, collected, and/or stored.

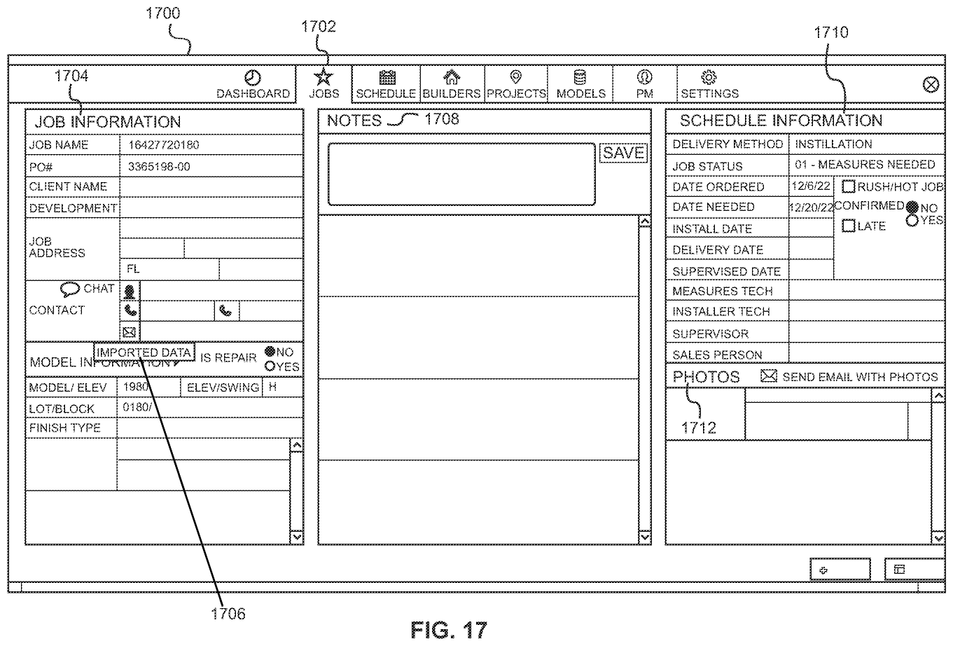

FIG. 17 is an illustration of a display or device including, but not limited to an electronic device, a tablet, a smart phone, and/or a computer having a screen with a graphic user interface. The display shows operational sequence 1700 that may be performed when running the computer program for receiving and facilitating the processing of a production order request via a web form in a maintenance work order workflow. At 1702, the jobs tab may be selected. At 1704, job information may be manually and/or automatically imported, collected, and/or stored. At 1706, imported data from emailed webform is displayed on the graphic user interface of the computer program. At 1708, notes may be manually and/or automatically imported, collected, and/or stored. At 1710, schedule information may be manually and/or automatically imported, collected, and/or stored. At 1712, photos may be manually and/or automatically imported, collected, and/or stored.

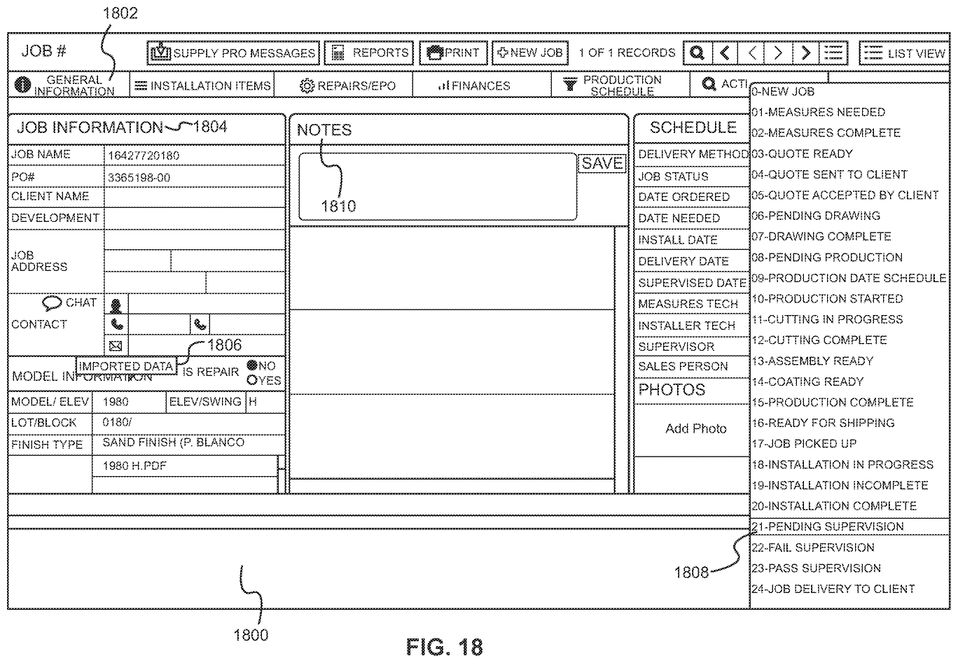

FIG. 18 is an illustration of a display or device including, but not limited to an electronic device, a tablet, a smart phone, and/or a computer having a screen with a graphic user interface. The display shows operational sequence 1800 that may be performed when running the computer program for receiving and facilitating the processing of a production order request via a web form in a maintenance work order workflow. At 1802, general information may be displayed pertaining to installation items, repairs/EPO, finances, and/or production schedule. At 1804, job information may be manually and/or automatically imported, collected, and/or stored. At 1806, imported data may be manually and/or automatically imported, collected, and/or stored. At 1808, pending supervision status is displayed. When a new job passes supervision, the status is changed to job complete. At 1810, notes may be manually and/or automatically imported, collected, and/or stored.

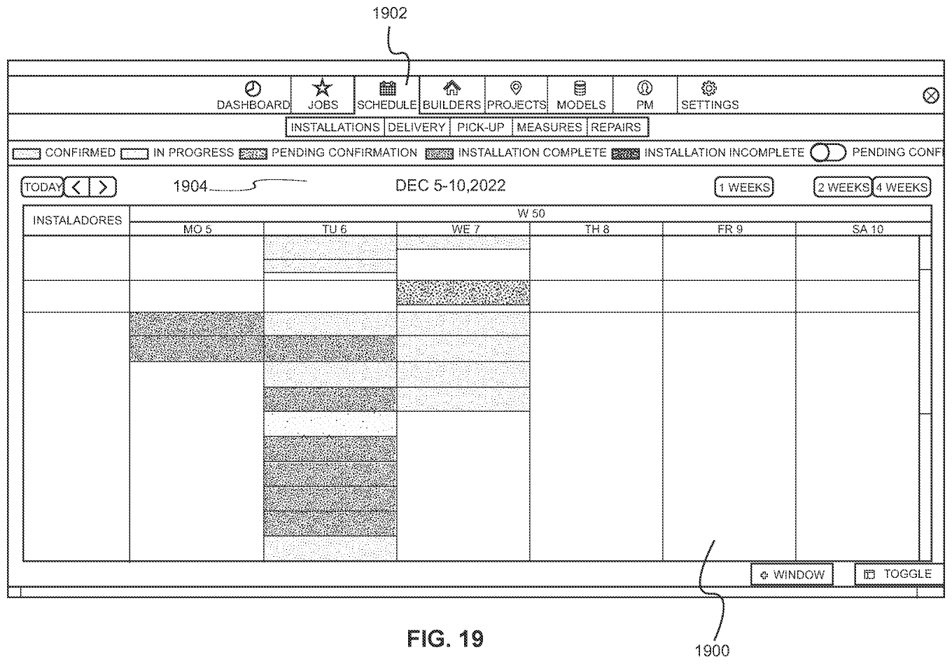

FIG. 19 is an illustration of a display or device including, but not limited to an electronic device, a tablet, a smart phone, and/or a computer having a screen with a graphic user interface. The display shows operational sequence 1900 that may be performed when running the computer program for receiving and facilitating the processing of a production order request via a web form in a maintenance work order workflow. At 1902, a schedule displayed information and a status report for installations, a delivery, a pick-up, measures, and/or repairs. At 1904, a calendar is displayed with information that may be manually and/or automatically imported, collected, and/or stored.

In some aspects, the techniques described herein relate to a computer-implemented data processing method for receiving and facilitating the processing of a production order request via a web form in a maintenance work order workflow, the method including the steps of: providing a computer system that includes a web form, said webform is configured to receive message data sent by a user, said computer system having an information policy, said computer system having a work order manager; providing a first data asset of a provider, said first data asset retains primary blueprint data; accessing, by at least one computer processor, a production order request transaction having at least one portion of secondary blueprint data associated with said production order request sent by a requester to said provider; displaying, by a computer display, said web form, said web form receives said production order request for processing; receiving, via said web form, said production order request from said requester, wherein said production order request is a request for said provider to perform at least one task associated with said at least one portion of said secondary blueprint data of said production order request, whereby, said provider obtains said at least one portion of said secondary blueprint data of said production order request; providing a second data asset, said second data asset retains a unique identifier corresponding to a location specific production order; determining the accuracy of said production order request from said requester by comparing said secondary blueprint data of said production order request from said web form to said at least a portion of said primary blueprint data of said first data asset; whereby, said production order request is accurate if said secondary blueprint data of said production order request from said web form matches said primary blueprint data of said first data asset, said production order request is not accurate if said secondary blueprint data of said production order request from said web form does not match said primary blueprint data of said first data asset; generating a proposal by said provider if said production order request is accurate; sending said proposal to said requester; receiving a unique identifier corresponding to a location specific production order; authorizing said request for said provider to perform said at least one task associated with said at least one portion of said secondary blueprint data of said production order request if said unique identifier is received by said provider; and, generating a work order by said provider.

In some aspects, the techniques described herein relate to a computer program including instructions which, when the program is executed by a computer, cause the computer to carry out the steps of: providing a template configured for collecting message data sent by a user; importing said message data sent by said user; identifying said message data; converting, using an information policy, said message data into said template; providing a first database separate from said template, said first database retaining master data; associating, using said information policy, said message data with said master data of said first database to extract job information from said message data; creating a proposal from the extracted job information, such that said proposal includes at least a portion of said master data and is customized for said user; sending said proposal to said user; providing a second database, said second database retaining location specific master data having a stock keeping unit, said stock keeping unit is associated with said location specific master data and packaged as a production order; providing a work order manager, said work order manager is configured to intercept said production order; associate said stock keeping unit with a group of tasks, and place, based on a work order policy, said stock keeping unit of said production order into said work order manager; and, automatically generating, from said production order, a list of products needed for the work order and for tasks therein.

In some aspects, the techniques described herein relate to a method, further including: said message data including a model and a blueprint.

In some aspects, the techniques described herein relate to a method, further including: said master data including a list of model data for a given model associated with its blueprint.

In some aspects, the techniques described herein relate to a method, further including: said job information is the stock keeping unit, builder name, model, and/or elevation.

In some aspects, the techniques described herein relate to a method, further including: said proposal including a list of items to produce, based on history production data.

In some aspects, the techniques described herein relate to a method, further including: said location specific maser data including data for a construction model, an elevation, and/or product pricing.

In some aspects, the techniques described herein relate to a method, further including: said stock keeping unit includes a construction model number, elevation, and product pricing.

In some aspects, the techniques described herein relate to a computer program including instructions which, when the program is executed by a computer, cause the computer to carry out the steps of: providing a template configured for collecting message data sent by a user, said message data is builder information and construction model information associated with a construction model; importing, using an information policy, said message data sent by said user; identifying, using said information policy, said message data; converting, using said information policy, said message data into a template; associating, using said information policy, said message data with a task; providing a first database separate from said template, said first database retaining production data and price data for said construction model, said production data is a list, said list having at least one product, said at least one product is assigned to said construction model, said at least one product is configured to be manufactured for and installed as part of said construction model as requested by said user, said price data is the cost of each of said at least one product from said list; comparing said builder information and/or said construction model information of said template to a matching construction model of said first database; creating, using said information policy, a proposal from said template, said proposal being customized for said user and having said production data and said price data for said matching construction model; sending, using said information policy, said proposal to said user; providing a second database, said second database retaining location specific construction model information for a plurality of construction models having a plurality of differing locations; generating a stock keeping unit, a different stock keeping unit is assigned to each of said construction models of said plurality of construction models, said stock keeping unit, having an associated construction model, is retained in said second database; assigning said stock keeping unit to said matching construction model of said proposal; sending a production order to a work order manager, said production order is associated with at least one of said stock keeping units for the matching construction model; automatically aggregating, using said work order manager, data from multiple jobs of the same user, that includes a group of production data and price data for each stock keeping unit of the associated construction model; and, automatically generating, production, scheduling, and installation associated with said production order.

In some aspects, the techniques described herein relate to a method, further including: said construction model information is a blueprint.

In some aspects, the techniques described herein relate to a method, further including: said construction model information is a model name.

In some aspects, the techniques described herein relate to a method, further including: said construction model information is an elevation.

In some aspects, the techniques described herein relate to a method, further including: said production data includes a bill of material.

The described embodiments are illustrative of the invention and are not exhaustive thereof. As work order generation systems evolve, further steps may be required in future embodiments of the invention but all such future embodiments are within the scope of this invention.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the description is intended to cover all of the generic and specific features of the invention herein described, and all statements of the scope of the invention that, as a matter of language, might be said to fall therebetween.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor of a general purpose computer, special purpose computer, or other programmable data processing apparatus (e.g., the computing device) to produce a machine, such that the instructions, which execute via the processor of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention.

It will be understood that each block and combinations of blocks in the diagrams, can be implemented by the computer readable program instructions. The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in one or more of the method steps. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Now that the invention has been described,

The invention claimed is:

1. A computer-implemented data processing method for receiving and facilitating the processing of a production order request via a web form in a maintenance work order workflow, the method comprising the steps of:
providing a computer system comprising a web form, the web form is configured to receive message data sent by a user, said computer system having an information policy, said computer system having a work order manager;
providing a first data asset of a provider, said first data asset retains primary blueprint data;
accessing, by at least one computer processor, a production order request transaction having at least one portion of secondary blueprint data associated with said production order request sent by a requester to said provider;
displaying, by a computer display, said web form, said web form receives said production order request for processing;
receiving, via said web form, said production order request from said requester, wherein said production order request is a request for said provider to perform at least one task associated with said at least one portion of said secondary blueprint data of said production order request, whereby, said provider obtains said at least one portion of said secondary blueprint data of said production order request;
providing a second data asset, said second data asset retains a unique identifier corresponding to a location specific production order;
determining accuracy of said production order request from said requester by comparing said secondary blueprint data of said production order request from said web form to said at least a portion of said primary blueprint data of said first data asset;
whereby, said production order request is accurate if said secondary blueprint data of said production order request from said web form matches said primary blueprint data of said first data asset, said production order request is not accurate if said secondary blueprint data of said production order request from said web form does not match said primary blueprint data of said first data asset;
generating a proposal by said provider if said production order request is accurate;
sending said proposal to said requester;
receiving a unique identifier corresponding to a location specific production order;
authorizing said request for said provider to perform said at least one task associated with said at least one portion of said secondary blueprint data of said production order request if said unique identifier is received by said provider; and
generating a work order by said provider.

2. A computer program comprising instructions which, when the program is executed by a computer, cause the computer to carry out the steps of:
providing a template configured for collecting message data sent by a user;
importing said message data sent by said user;
identifying said message data;
converting, using an information policy, said message data into said template;
providing a first database separate from said template, the first database retaining master data;
associating, using said information policy, said message data with said master data of said first database to extract job information from said message data;
creating a proposal from the extracted job information, such that said proposal comprises at least a portion of said master data and is customized for said user;
sending said proposal to said user;
providing a second database, said second database retaining location specific master data having a stock keeping unit, said stock keeping unit is associated with said location specific master data and packaged as a production order;
providing a work order manager, said work order manager is configured to intercept said production order;
associate said stock keeping unit with a group of tasks, and place, based on a work order policy, said stock keeping unit of said production order into said work order manager; and
automatically generating, from said production order, a list of products needed for the work order and for tasks therein.

3. The computer program of claim 2, further comprising:
said message data comprising a model and a blueprint.

4. The computer program of claim 2, further comprising:
the master data comprising a list of model data for a given model associated with its blueprint.

5. The computer program of claim 2, further comprising:
said job information is the stock keeping unit, builder name, model, and/or elevation.

6. The computer program of claim 2, further comprising:
said proposal comprising a list of items to produce, based on history production data.

7. The computer program of claim 2, further comprising:
said location specific master data comprising data for a construction model, an elevation, and/or product pricing.

8. The computer program of claim 2, further comprising:
said stock keeping unit comprises a construction model number, elevation, and product pricing.

9. A computer program comprising instructions which, when the program is executed by a computer, cause the computer to carry out the steps of:
providing a template configured for collecting message data sent by a user, said message data is builder information and construction model information associated with a construction model;
importing, using an information policy, said message data sent by the user;
identifying, using said information policy, said message data;
converting, using said information policy, said message data into a template;
associating, using said information policy, said message data with a task;
providing a first database separate from said template, said first database retaining production data and price data for said construction model, said production data is a list, said list having at least one product, said at least one product is assigned to said construction model, said at least one product is configured to be manufactured for and installed as part of said construction model as requested by the user, said price data is a cost of each of said at least one product from said list;
comparing said builder information and/or said construction model information of said template to a matching construction model of said first database;
creating, using said information policy, a proposal from said template, said proposal being customized for said user and having said production data and said price data for said matching construction model;
sending, using said information policy, said proposal to said user;
providing a second database, said second database retaining location specific construction model information for a plurality of construction models having a plurality of differing locations;
generating a stock keeping unit, a different stock keeping unit is assigned to each of said construction models of said plurality of construction models, said stock keeping unit, having an associated construction model, is retained in said second database;
assigning said stock keeping unit to said matching construction model of said proposal;
sending a production order to a work order manager, said production order is associated with at least one of said stock keeping units for the matching construction model;
automatically aggregating, using said work order manager, data from multiple jobs of the same user, that comprises a group of production data and price data for each stock keeping unit of the associated construction model; and
automatically generating, production, scheduling, and installation associated with said production order.

10. The computer program of claim 9, further comprising:
said construction model information is a blueprint.

11. The computer program of claim 9, further comprising:
said construction model information is a model name.

12. The computer program of claim 9, further comprising:
said construction model information is an elevation.

13. The computer program of claim 9, further comprising:
said production data comprises a bill of material.
